(19) United States
(12) Patent Application Publication
(10) Pub. No.: US 2009/0094098 A1
(43) Pub. Date: Apr. 9, 2009

(54) Promotion of a wine industry

(76) Inventor: Janos Farkas, Austin, TX (US)

Correspondence Address: Ashok Tankha, Of Counsel, Lipton, Weinberger & Husick, 36 Greenleigh Drive, Sewell, NJ, 08080, US

(21) Appl. No.: 11/906,980

(22) Filed: Oct. 4, 2007

(51) Int. Cl. G06Q 30/00

(52) U.S. Cl. 705/10; 705/14

(57) ABSTRACT

Disclosed herein is a method and system for promoting a first wine industry of a first geographical location utilizing a plurality of advertising media. In a first embodiment, the plurality of advertising mediums is selected for promoting the first wine industry. The disclosed method links information of contribution of the first wine industry to a second wine industry. The information is publicized in a plurality of locations. In a second embodiment, the first wine industry is promoted utilizing a web portal. The web portal comprises a first set of information of the first wine industry and a second set of information of the second wine industry. The web portal establishes a virtual link between the first set of information and the second set of information. Further, revenue may be generated through the advertising mediums and targeted advertising.

### BACKGROUND

This invention, in general, relates to wine industries. More particularly, this invention relates to promoting a wine industry utilizing multiple advertising mediums.

The marketing and sale of wines depend on one or more criteria including the type of wine, taste, year of production, country of production, and historical and current facts of the wine. Often, a customer is not aware of the historical facts associated with a wine. Furthermore, the customer may not be aware of the different wines produced in different geographical locations. The wines produced in a particular geographical location may have historical pedigrees known only to a small faction of customers or potential customers who are local or who reside outside the region where the wines are cultivated. Therefore, there is a need to popularize the wines produced from a particular geographical location.

There is an unmet need for a method and system for promoting the wine industry of a geographical location nationally and internationally, utilizing multiple advertising mediums.

### SUMMARY OF THE INVENTION

The method and system disclosed herein addresses the need for promoting a first wine industry of a first geographical location nationally and internationally. The above stated need is addressed by publicizing information of the contribution of the first wine industry to a second wine industry of a second geographical location through a plurality of advertising mediums.

In a first embodiment of the method disclosed herein, the first wine industry of the first geographical location is promoted by utilizing multiple advertising mediums. The advertising mediums exemplarily include magazines, brochures, flyers, indoor advertising signs, outdoor advertising signs, billboards, audio media, video media and the internet. The advertising mediums are selected for the promotion of the first wine industry. The first wine industry is promoted by linking information of the contribution of the first wine industry to the second wine industry. The information of the contribution of the first wine industry is usage of vine rootstocks and vines of the first wine industry in the second wine industry.

The contribution information is publicized in multiple locations through the advertising mediums. The locations are one or more of public transport stations, roads and highways, wine territories, sponsor locations, winery locations, vineyard locations, wine distributor locations, wine retailer locations, restaurants, hotels, and other public accommodations. Revenue is generated from the publicized information through the advertising mediums. Exemplarily, the advertisements of wines, wineries, and vineyards of producers, wine distributors, and wine retailers are advertised through the advertising mediums along with the publicized information.

In a second embodiment of the method disclosed herein, the first wine industry of the first geographical location is promoted by utilizing a web portal. The web portal provides information of the contribution of the first wine industry to the second wine industry. A first set of information on wines, wineries, and vineyards of the first wine industry of the first geographical location is provided on the web portal. A second set of information on wines, wineries, and vineyards of the second wine industry of the second geographical location is provided on the web portal. The web portal establishes a virtual link between the first set of information and the second set of information based on the information of the contribution of the first wine industry to the second wine industry.

Further, the web portal publishes a wine directory for the promotion of the first wine industry. The wine directory includes information on wine producers, year of wine production, and ranking of the wines of the first wine industry. The web portal generates revenue through targeted advertising on the web portal. Revenue is generated for the first wine industry through targeted advertising on the web portal. The revenue may also be generated by publicizing information of the contribution of the first wine industry to the second wine industry in multiple locations. The targeted advertising comprises the step of hosting one or more of advertisements of wines, wineries, and vineyards of producers, wine distributors, and wine retailers on the web portal. In addition, the web portal hosts tourism related information associated with the first wine industry. The tourism related information is used to obtain additional targeted advertisements from one or more of airlines, hotels, restaurants, car rental agencies, etc. Further, due to the generated internet traffic, non-wine related companies such as financial institutions, jewelry stores, automobile manufacturers, real estate developers, and builders, mostly associated with wine consumers may also advertise on the web portal.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of promoting a first wine industry of a first geographical location utilizing multiple advertising mediums.

FIG. 2 illustrates a method of promoting a first wine industry of a first geographical location utilizing a web portal.

FIG. 3 illustrates a system for promoting a first wine industry of a first geographical location utilizing a web portal.

FIG. 4 exemplarily illustrates components of a web portal of a first wine industry.

FIG. 5 exemplarily illustrates a web portal of a first wine industry with a link to a second wine industry.

FIG. 6 exemplarily illustrates a web portal for promoting a first wine industry of a first geographical location.

### DETAILED DESCRIPTION OF THE INVENTION

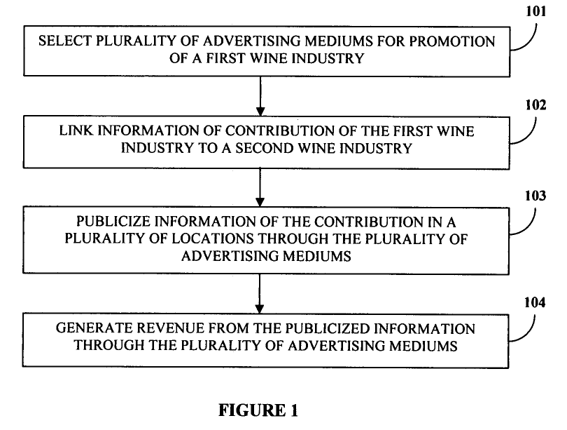

FIG. 1 illustrates a method of promoting a first wine industry of a first geographical location utilizing multiple advertising mediums. Multiple advertising mediums are selected 101 for the promotion of the first wine industry. The first wine industry includes wines, wineries, vineyards of producers of the first geographical location, and worldwide distributors and retailers of the first wine industry. The advertising mediums include magazines, brochures, flyers, indoor advertising signs, outdoor advertising signs, billboards, audio media, video media, and the internet. The promotion of the first wine industry comprises linking 102 information of contribution of the first wine industry to a second wine industry of a second geographical location. The second wine industry includes wines, wineries, vineyards of producers of the second geographical location, and worldwide distributors and retailers of the second wine industry. The first geographical location is an area to be developed or expanded for the production and marketing of wines. For example, the first geographical location may be the state of Texas. The second geographical location is an area known for production of internationally recognized wines. For example, the second geographical location may be France. The contribution information of the first wine industry is advertised nationally and internationally utilizing the advertising mediums.

The information of the contribution of the first wine industry is usage of vine rootstocks and vines of the first wine industry in the second wine industry. Exemplarily, the contribution of the first wine industry may be associated with Thomas V. Munson also known as the “father of Texas viticulture”. Thomas V. Munson from Denison, Tex., developed disease resistant grape vine rootstocks used for grafting the grape vine, Vitis Vinifera. The native rootstocks developed by Thomas V. Munson protect the grape vine, Vitis Vinifera from the pest, Phylloxera. Phylloxera infects the roots of the grape vine, whereby the flow of nutrients and water to the grape vine is inhibited, thereby destroying the grape vine in the vineyards. In the year 1880, the Phylloxera plague was rampant in France, particularly in the Charante region of France where the city of Cognac is located. The Phylloxera root louse damaged the French wine grapes and vineyards, thereby affecting the economy of France. France assigned the French scientist, Pierre Viala to find a cure for the Phylloxera plague.

In order to find a cure for the plague, Pierre Viala consulted with Thomas V. Munson and together they collaborated on the problem in Denison and various other locations in Texas to view the native grapes of Texas in their natural habitat. They found that the soils of the Charante region of France and Denison are very similar and therefore the grape species, Vitis Vinifera, is capable of growing in either location. T. V. Munson suggested that the only way to save the French vineyards was to graft the Vitis vinifera varieties to the Phylloxera resistant rootstocks. Based on Munson's suggestion, thousands of bundles of Texas wine rootstocks were shipped to France where Pierre Viala and other French scientists started educating the French wine growers on the enormous grafting tasks that lay ahead.

As a result, the Phylloxera resistant rootstocks developed by Thomas V. Munson were responsible for saving the vineyards of France and other vineyards of Europe from damage and possible extinction. T. V. Munson was awarded the Chevalier du Merite Agricola and was inducted into the Legion of Honor in 1888 for his contribution to the French wine industry. Further, the contribution of Thomas V. Munson led to the establishment of a sister city relationship between the city of Cognac and Denison in the year 1992.

The information regarding the contribution of the first wine industry to the second wine industry is publicized 103 in multiple locations through the advertising mediums. The locations are one or more of public transport stations, roads and highways, wine territories, sponsor locations, winery locations, vineyard locations, wine distributor locations, wine retailer locations, restaurants, hotels, and other public accommodations. The method disclosed herein further generates 104 revenue from the publicized information of the contribution of the first wine industry through the advertising mediums. Revenue for the first wine industry may be generated from advertisements of wines, wineries, and vineyards of producers, wine distributors, and wine retailers in the advertising mediums, etc. The advertisements of wines, wineries, and vineyards are also used for promoting wine tourism in the first geographical location. Further, wine tourism in the first geographical location may also be used to promote the first wine industry. The wine tourism also adds to the revenue of the first wine industry of the first geographical location. Exemplarily, about twenty percent of the revenue generated by the wine produced in the first geographical location may be derived from tourism through the sale of wine and through wine tasting by visitors. Further, the money spent by tourists in the region of the first wine industry may be significantly more than the winery revenues in the state of Texas.

Further, sponsorship may be obtained from multiple sponsors for promoting the first wine industry. The sponsors are one or more of companies, wine producers, wine distributors, wine retailers, governmental and non-governmental organizations, financial institutions, hotels, airlines, car rental agencies, food stores and individuals. The step of generating revenue for the first wine industry through the advertising mediums further comprises outdoor advertising. The outdoor advertising may include obtaining land on lease for promoting the first wine industry. The leased land may be used for placing billboards for promoting the first wine industry. Further, the cost of obtaining the land on lease may be covered by the sponsors. The sponsors may also place outdoor advertisements in the sponsors' premises for promoting the first wine industry. Furthermore, the first wine industry is advertised by providing printed materials to the wineries, vineyards, and wine distributors for distribution purposes. The wineries, vineyards, and the wine distributors may distribute and use the copyrighted and trademarked printed materials. The wineries, vineyards and the wine distributors may provide donations for the usage of the printed materials. The copyrighted and trademarked printed materials may be distributed by the wineries, vineyards, and the wine distributors with or without paying additional license fees. Furthermore, the wineries, vineyards, and the wine distributors may pay royalty for distributing and using the copyrighted and trademarked printed materials. The first wine industry may be provided with additional grants and funds by the state authorities of the first geographical location for the promotion of the first wine industry.

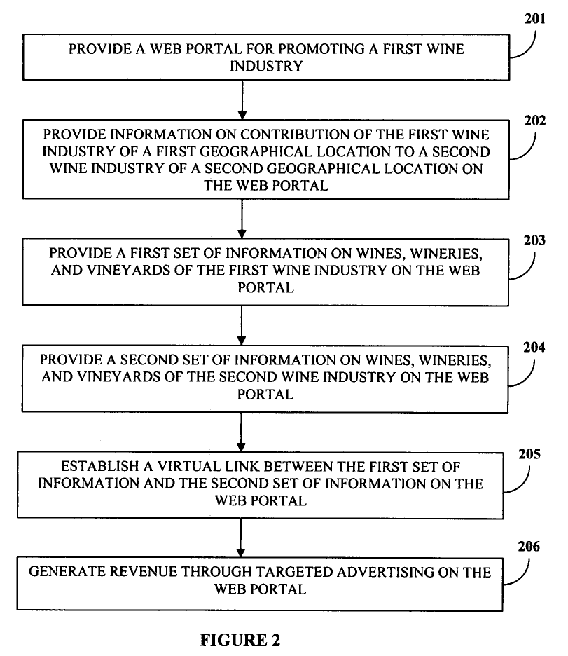

FIG. 2 illustrates a method of promoting a first wine industry of a first geographical location utilizing a web portal 300. The method disclosed herein provides 201 the web portal 300 for promoting the first wine industry. The first wine industry is promoted by providing 202 information on the contribution of the first wine industry of the first geographical location to a second wine industry of a second geographical location, on the web portal 300. A first set of information on wines, wineries, and vineyards of the first wine industry is provided 203 on the web portal 300. A second set of information on wines, wineries, and vineyards of the second wine industry of the second geographical location is provided 204 on the web portal 300.

A virtual link is established 205 between the first set of information of the first wine industry and the second set of information of the second wine industry on the web portal 300. The virtual link is based on the information of the contribution of the first wine industry to the second wine industry. The first geographical location is an area to be developed or to be expanded for producing and marketing wines. For example, the first geographical location may be the state of Texas. The second geographical location is an area known for production of internationally recognized wines, for example, France. The information of the contribution of the first wine industry to the second wine industry includes information on the usage of vine rootstocks and vines of the first wine industry in the second wine industry. An example of the contribution of the first wine industry associated with Thomas V. Munson is explained in the detailed description of FIG. 1.

Further the web portal 300 is used for generating 206 revenue through targeted advertising on the web portal 300. Revenue may also be generated by publicizing information of the contribution of the first wine industry to the second wine industry in multiple locations. Sponsorship may also be obtained from multiple sponsors for promoting the first wine industry. The web portal is used to host tourism related information associated with the first wine industry. The tourism related information is used to obtain targeted advertisements from one or more of restaurants, hotels, airlines, car rental agencies, financial institutions, jewelry stores, automobile manufacturers, real estate developers, and builders.

The promotion of the first wine industry further includes the step of hosting advertisements on an advertising website. The advertising website hosts advertisements of wines, wineries, and vineyards of producers, wine distributors, wine retailers, restaurants, hotels, airlines, car rental agencies, financial institutions, jewelry stores, automobile manufacturers, real estate developers, and builders. The advertising website may host targeted advertisements, exemplarily, provided by Google™ AdSense, Yahoo® search marketing, etc. The web portal 300 may also be promoted by hosting advertisements on Google™ AdWords, whereby the internet traffic accessing these advertisements on Google™ AdWords are redirected to the web portal 300. For example, an advertisement on French wines may be posted on Google™ AdWords. Web users accessing this advertisement on Google™ AdWords will be redirected to the web portal 300.

Further, a wine directory of the first wine industry is published on the web portal 300. The wine directory includes information on wine producers, year of wine production, and ranking of wines of the first wine industry. The promotion of the first wine industry further includes the step of online merchandising of products on the web portal 300. The web portal 300 also includes a provision for modifying the information of the first wine industry on the web portal 300.

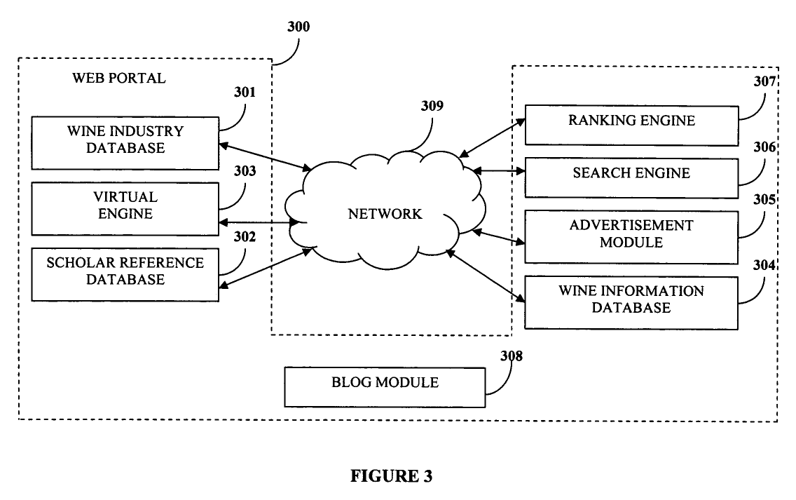

FIG. 3 illustrates a system for promoting a first wine industry of a first geographical location utilizing a web portal 300. The system disclosed herein comprises a wine industry database 301, a virtual engine 303, a scholar reference database 302, a wine information database 304, an advertising module 305, a search engine 306, a ranking engine 307, and a blog module 308. The wine industry database 301 stores a first set of information on wines, wineries, and vineyards of the first wine industry and a second set of information on wines, wineries, and vineyards of a second wine industry. The virtual engine 303 establishes a virtual link between the first set of information and the second set of information on the web portal. The virtual link is established using the information of contribution of the first wine industry to the second wine industry. The information of the contribution of the first wine industry includes, for example, information on the usage of vine rootstocks and vines of the first wine industry in the second wine industry of the second geographical location. The contribution information is stored in the wine industry database 301 and the scholar reference database 302. The virtual link between the first set of information and the second set of information is established by the virtual engine 303 through a physical and a virtual network 309. The web portal 300 also includes a provision for modifying the information of the first wine industry and the second wine industry.

The advertisement module 305 is used for targeted advertising on the web portal 300. The web portal 300 hosts advertisements of wines, wineries, and vineyards of producers, wine distributors, wine retailers, restaurants, hotels, airlines, car rental agencies, financial institutions, jewelry stores, automobile manufacturers, real estate developers, and builders using the advertisement module 305. The advertisements of wines, wineries, and vineyards of producers, wine distributors, and wine retailers on the web portal 300 promote wine tourism in the first geographical location. The tourism related to the winery in the first geographical location promotes the first wine industry.

The information of the wines, wineries, and vineyards of the first wine industry are classified in the wine information database 304. The wine information is classified based on wine producers, year of production, and ranking of the wines. The ranking engine 307 provided on the web portal 300 is used to rank the wines of the first wine industry. The ranking engine 307 is managed by authorized wine tasters for ranking the wines. The search engine 306 on the web portal 300 performs a search on wines, wineries, and vineyards of the first wine industry and the second wine industry. The scholar reference database 302 stores information on one or more of books, magazines, and articles related to the contribution of the first wine industry. The blog module 308 is used for posting views and comments on topics related to the first wine industry and the second wine industry.

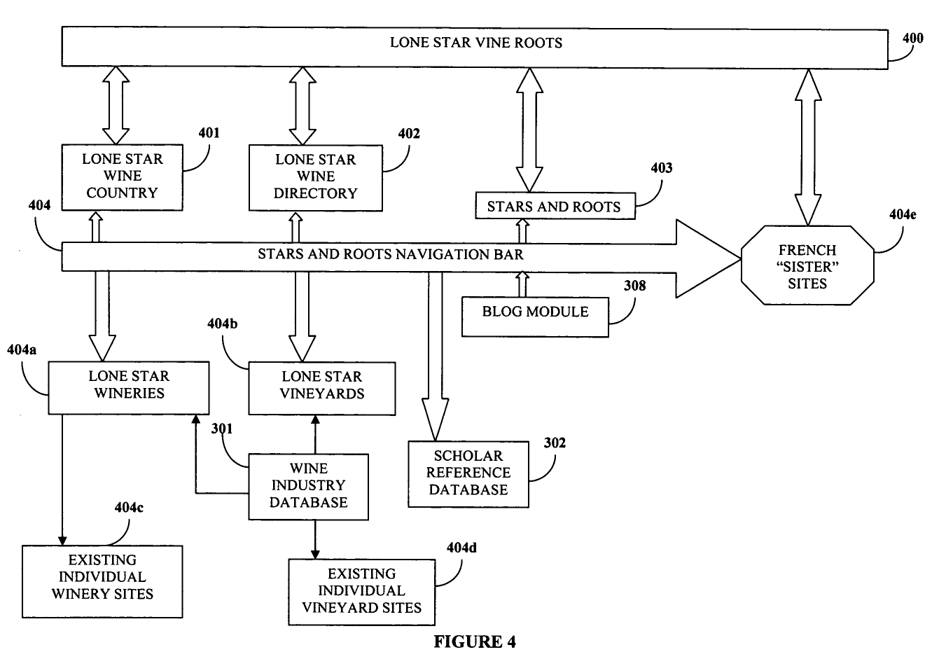

FIG. 4 exemplarily illustrates components of a web portal 300 of the first wine industry. The web portal 300 of the first wine industry is exemplarily illustrated as “Lone Star Vine Roots” 400. The web portal 300 includes a navigation bar, for example, the “Stars and Roots Navigation Bar” component 404 for navigating the web portal 300. The “Stars and Roots Navigation Bar” component 404 is used to navigate the web pages comprising information on the wineries, and vineyards of the first wine industry and the second wine industry. The information on the wineries and vineyards of the first wine industry and the second wine industry is stored in a wine industry database 301. A “Lone Star Wine Country” component 401 includes information on the wineries and vineyards of the first wine industry of the first geographical location. The information on the wineries of the first wine industry may be accessed using the “Lone Star Wineries” component 404a on the web portal 300. The “Lone Star Wineries” component 404a may include information of existing individual winery web sites 404c of the first wine industry. The information on the vineyards of the first wine industry may be accessed using the “Lone Star Vineyards” component 404b on the web portal 300. The “Lone Star Vineyards” component 404b may include information of existing individual vineyard web sites 404d of the first wine industry. The scholar reference database 302 stores information on one or more of books, magazines and articles related to the contribution of the first wine industry. The information on the wines, wineries, and vineyards of the second wine industry may be accessed using the “French Sister Sites” component 404e via the web portal 300. The “French Sister Sites” component 404e may also include information of existing individual web sites of the wines, wineries, and vineyards of the second wine industry.

The web portal 300 further includes a wine directory 402, namely the “Lone Star Wine Directory” component for storing information on the wines. The wine directory 402 includes comprehensive information on the wines, wineries and vineyards of the first wine industry. The wine directory 402 lists information on wines that are classified based on one of wine producers, year of production, and ranking of the wines of the first wine industry. The wines may be classified according to the producer regions of wines of the first geographical location. Exemplarily, the producers of wines may be classified as wine producers of northern region, southern region, eastern region, and western region of the first geographical location. The producers of wines may also be classified based on appellations. Further, the wines may be classified according to the year of production of the wines. The wines of the first geographical location are also ranked in the wine directory 402. The ranking of the wines may be based on the ratings provided by multiple wine tasters of the wine industry. The navigation bar also links the web portal 300 to a “Stars And Roots” component 403 on the web portal 300. The “Stars And Roots” component 403 includes a blog module 308 for posting views and comments on topics related to the first wine industry and the second wine industry. Further, the “Stars And Roots” component comprises information on grafted rootstocks and vines transferred between different geographical locations.

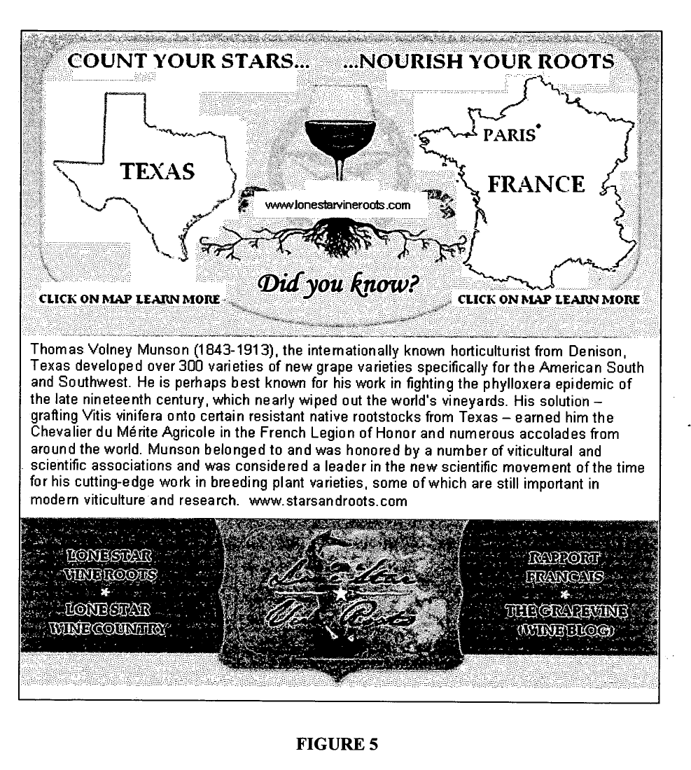

FIG. 5 exemplarily illustrates a web portal 300 of a first wine industry with a link to a second wine industry. The web portal 300 of the first wine industry is exemplarily illustrated as “Lone Star Vine Roots” 400. The web portal 300 includes a first map of the first geographical location and a second map of the second geographical location. The first map and the second map provide visual interfaces to access the information of wines, wineries, and vineyards of different regions of the first and the second geographical locations. The web portal 300 further displays information of contribution of the first wine industry to the second wine industry. The contribution information may be accessed by clicking on a “Stars And Roots” link of the web portal 300. The contribution of the first wine industry includes information on usage of vine rootstocks and vines of the first geographical location in a second wine industry of a second geographical location. The first wine industry includes wines, wineries, and vineyards of Texas and the second wine industry includes wines, wineries, and vineyards of France.

The web portal 300 includes an advertising space for targeted advertising. The step of targeted advertising includes hosting advertisements of wines, wineries, and vineyards of producers, wine distributors, wine retailers, restaurants, hotels, airlines, car rental agencies, financial institutions, jewelry stores, automobile manufacturers, real estate developers and builders. The web portal 300 further includes a link to the “The Lone Star Wine Country” 401 web portal. “The Lone Star Wine Country” 401 web portal of the web portal 300 includes information on the wineries and vineyards of the first wine industry of the first geographical location. The information on the wineries and vineyards include links to existing wineries and vineyards sites of the first geographical location. The web portal 300 further includes a link, namely “The Grapevine”. “The Grapevine” is a wine blog for posting views and comments on topics related to the first wine industry and the second wine industry. The web portal 300 may also include a “Stars And Roots” blog for posting views and comments on the contribution of the first wine industry.

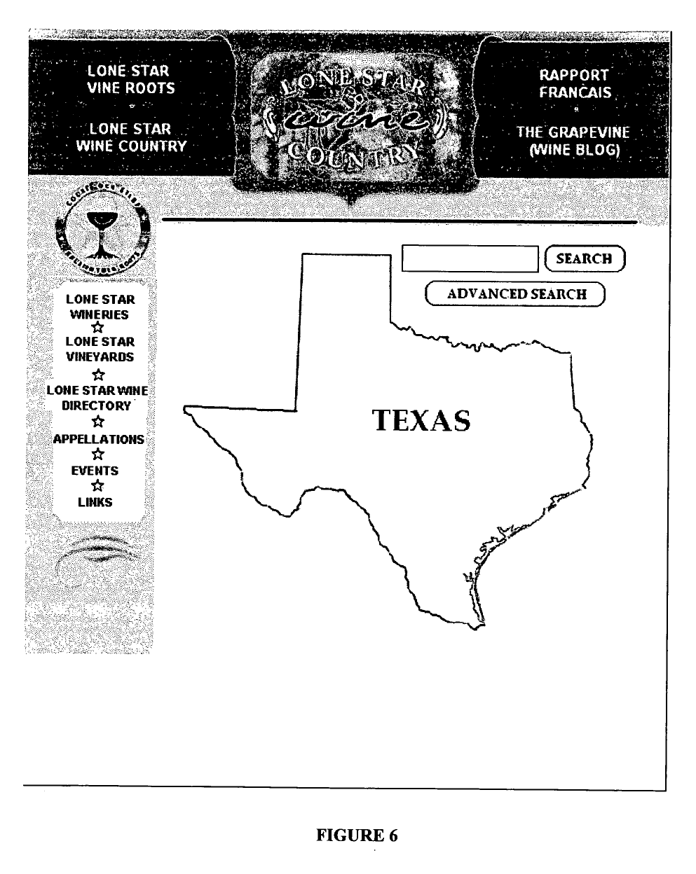

FIG. 6 exemplarily illustrates a web portal 300 for promoting a first wine industry of a first geographical location. The web portal 300 of the first wine industry is exemplarily illustrated as “Lone Star Wine Country” 401. The “Lone Star Wine Country” 401 web portal comprises links to “Lone Star Wineries” 404a, “Lone Star Vineyards” 404b, and “Lone Star Wine Directory” 402 as explained in the detailed description of FIG. 4. The “Lone Star Wine Country” 401 web portal also includes a search engine 306 for performing a search on wines, wineries, and vineyards of the first wine industry and the second wine industry. Further, the “Lone Star Wine Country” 401 web portal includes a link to “Appellations”. The “Appellations” link comprises information on the producers of wines classified based on appellations. The “Links” on the “Lone Star Wine Country” 401 web portal directs the web users toward existing individual winery web sites 404f and vineyard web sites 404g of the first wine industry. The update of the events of the first wine industry may be accessed through the “Events” link on the “Lone Star Wine Country” 401 web portal. The “Lone Star Wine Country” 401 web portal further comprises links to “Lone Star Wine Roots” 400, “Rapport Francais”, and “The Grapevine” blog as explained in the detailed description of FIG. 5.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire, and fiber optics, including the wires that comprise a system bus coupled to the processor. Transmission media may include or convey acoustic waves, light waves, and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the wine industry database 301, the wine information database 304, and the scholar reference database 302, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc, that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of promoting a first wine industry of a first geographical location utilizing a plurality of advertising mediums, comprising the steps of:
selecting said plurality of advertising mediums for said promotion of said first wine industry;
linking information regarding contribution of the first wine industry to a second wine industry of a second geographical location;
publicizing said information of said contribution in a plurality of locations through the plurality of advertising mediums;
whereby the first wine industry is promoted nationally and internationally by publicizing the information of the contribution of the first wine industry to the second wine industry through the plurality of advertising mediums.

2. The method of claim 1, wherein said promotion is used to generate revenue for the first wine industry through the plurality of advertising medium.

3. The method of claim 1, wherein the information of the contribution of the first wine industry is usage of vine rootstocks and vines of the first wine industry in the second wine industry.

4. The method of claim 1, wherein the first wine industry and the second wine industry comprise wines, wineries, and vineyards of said first geographical location and said second geographical location respectively.

5. The method of claim 1, wherein the first geographical location is an area to be developed for producing and marketing wines and the second geographical location is an area known for production of internationally recognized wines.

6. The method of claim 1, wherein the first geographical location is Texas and the second geographical location is France.

7. The method of claim 1, wherein the plurality of advertising mediums comprises one or more of magazines, brochures, flyers, indoor advertising signs, outdoor advertising signs, billboards, audio media, video media, and internet.

8. The method of claim 1, wherein said plurality of locations comprises one or more of public transport stations, roads and highways, wine territories, sponsor locations, winery locations, vineyard locations, wine distributor locations, wine retailer locations, restaurants, hotels, and public accommodations.

9. The method of claim 1, further comprising the step of obtaining sponsorship from a plurality of sponsors for promoting the first wine industry, wherein said plurality of sponsors is one of companies, wine producers, wine distributors, wine retailers, governmental and non governmental organizations, financial institutions, hotels, airlines, car rental agencies, food stores, and individuals.

10. A computer implemented method of promoting a first wine industry of a first geographical location utilizing a web portal, comprising the steps of:
providing said web portal for promoting said first wine industry;
providing information on contribution of the first wine industry of said first geographical location to a second wine industry of a second geographical location on the web portal;
providing a first set of information on wines, wineries, and vineyards of the first wine industry on the web portal;
providing a second set of information on wines, wineries, and vineyards of said second wine industry of said second geographical location on the web portal;
establishing a virtual link between said first set of information of the first wine industry and said second set of information of the second wine industry on the web portal, wherein said virtual link is based on said information of said contribution of the first wine industry to the second wine industry; and
generating revenue through targeted advertising on the web portal;
whereby the first wine industry is promoted nationally and internationally through the web portal.

11. The computer implemented method of claim 10 wherein said web portal is used to generate revenue for the first wine industry through targeted advertising on the web portal.

12. The computer implemented method of claim 9, wherein the information of the contribution of the first wine industry is usage of vine rootstocks and vines of the first wine industry in the second wine industry;

13. The computer implemented method of claim 9, further comprising the step of publishing a wine directory on the web portal for said promotion of the first wine industry, wherein said wine directory comprises information on wine producers, year of wine production, and ranking of wines of the first geographical location.

14. The computer implemented method of claim 9, further comprising online merchandising of products on the web portal for promoting the first wine industry.

15. The computer implemented method of claim 9, further comprising a step of hosting tourism related information associated with the first wine industry on the web portal, wherein said tourism related information is used to obtain targeted advertisements from one or more of restaurants, hotels, airlines, car rental agencies, financial institutions, jewelry stores, automobile manufacturers, real estate developers, and builders.

16. A computer implemented system for promoting a first wine industry of a first geographical location utilizing a web portal, comprising:
a wine industry database for storing a first set of information on wines, wineries, and vineyards of said first wine industry and a second set of information on wines, wineries, and vineyards of a second wine industry;
a virtual engine for establishing a virtual link between said first set of information and said second set of information on said web portal, wherein said virtual link is based on information of contribution of the first wine industry to said second wine industry; and
an advertisement module for targeted advertising on the web portal.

17. The computer implemented system of claim 14, further comprising a wine information database for storing information on wine producers, year of wine production, and ranking of said wines of said first geographical location.

18. The computer implemented system of claim 14, further comprising a ranking engine for ranking said wines.

19. The computer implemented system of claim 14, further comprising a search engine for performing a search on a plurality of wines, wineries, and vineyards of the first wine industry and the second wine industry.

20. The computer implemented system of claim 14, wherein said advertisement module is used for hosting targeted advertisements, wherein said targeted advertisements include advertisements of a plurality of wines, wineries, and vineyards of producers, wine distributors, wine retailers, restaurants, hotels, airlines, car rental agencies, financial institutions, jewelry stores, automobile manufacturers, real estate developers, and builders.

21. The computer implemented system of claim 14, further comprising a scholar reference database for storing information on one or more of books, magazines and articles related to the contribution of the first wine industry.

22. The computer implemented system of claim 14, further comprising a blog module used for posting views and comments on topics related to the first wine industry and the second wine industry.

23. A computer program product comprising computer executable instructions embodied in a computer-readable medium, wherein said computer program product comprises:
a first computer parsable program code for providing a web portal for promoting a first wine industry;
a second computer parsable program code for providing information on contribution of the first wine industry of the first geographical location to a second wine industry of a second geographical location on the web portal;
a third computer parsable program code for providing a first set of information on wines, wineries, and vineyards of the first wine industry on the web portal;
a fourth computer parsable program code for providing a second set of information on wines, wineries, and vineyards of the second wine industry of the second geographical location on the web portal;
a fifth computer parsable program code for establishing a virtual link between the first set of information of the first wine industry and the second set of information of the second wine industry on the web portal; and
a sixth computer parsable program code for generating revenue through targeted advertising on the web portal.
